(19) United States
(12) Patent Application Publication
(10) Pub. No.: US 2009/0276953 A1
(43) Pub. Date: Nov. 12, 2009

(54) DIVERTER ASSEMBLY FOR USE IN HOLDING SHOWER HEAD AND SHOWER NOZZLE

(75) Inventors: Wei-Mien Hsu, Taichung County (TW); Chun-Hung Li, Taichung County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: GLOBE UNION INDUSTRIAL CORP., Taichung County (TW)

(21) Appl. No.: 12/118,337

(22) Filed: May 9, 2008

(51) Int. Cl. A47K 3/28; B05B 1/16; B05B 15/06; F16K 11/00

(52) U.S. Cl. 4/601; 239/283; 239/447; 137/625.4; 137/360

(57) ABSTRACT

A diverter assembly includes a main body, a valve device and a movable body. The main body is hollow and has a water inlet tube and two water outlet tubes. One of the two water outlet tubes is communicated through a hose to a shower nozzle. The valve device is disposed on the main body and has a valve capable of linearly moving back and forth for steplessly communicating the water inlet tube with either or both of the water outlet tubes. The movable body is pivotally disposed at one end of the main body, and has a hole for the shower nozzle to be inserted in. Thereby, the diverter assembly can steplessly adjust the valve position for controlling the water to flow out from either or both of the water outlet tubes.

### BACKGROUND OF THE INVENTION

1. Field of Invention

The present invention relates to a diverter assembly for shower, and more particularly to a diverter assembly for holding a shower nozzle, and for controlling the amount of water to flow out through either or both of a shower head and a shower nozzle steplessly.

2. Related Art

Typical American shower appliances include a shower head fixed on a wall and a shower nozzle for a user to hold, and a diverter is disposed between the shower head and the shower nozzle for controlling the water to flow out through either or both of the shower head and the nozzle.

U.S. Pat. No. 7,299,510 discloses a holder device for a shower head and a shower nozzle as described above. The holder device includes an inlet and two outlet ports. A knob is pivotally disposed at one end of the holder device to operate a valve stem disposed inside the holder device for controlling the water flowing directions. An attaching device is disposed at the other end of the holder device for holding the shower nozzle.

The two outlet ports of the holder device pass through a chamber, and the valve stem switches a valve member to positions corresponding to either one of the two outlet ports or between the two outlet ports. That is to say, when the valve stem switches the valve member to the position corresponding to one of the outlet ports, the water flows out through the other outlet port. When the valve stem switches the valve member to the position between the two outlet ports, the water flows out through both of the outlet ports.

Although the above-mentioned controlling technique of the three valve stem positions satisfies basic needs of users, when the valve stem switches to the position to have the water flow out through both of the outlet ports, that is, when the water flows out through both of the shower head and the shower nozzle, users can not further adjust the amount of the water flowing out through both of the shower head and the shower nozzle. The above situation is obviously to be improved for users.

On the other hand, an attaching device for the shower nozzle to be attached thereto includes a follower rotatably disposed on a partition secured to the holder device for the attaching device to be rotated along with the follower and for the opening of the attaching device to change the angle so that users can handle the shower nozzle or attach it in the holder device.

However, there is nothing between the attaching device and the partition for securing the attaching device, and the securing of the attaching device comes from the friction among the follower, the attaching device and the partition. If the screw for securing the follower and the attaching device is loosen, or after being used for a long time, a wearing issue occurs among the follower, the attaching device and the partition such that the attaching device loses securing capability, resulting in the falling of the shower nozzle secured in the attaching device. The falling of the shower nozzle can result in damaging of the shower nozzle or other appliance, or more seriously, hurt users thereof. Therefore, the attaching device is needed to be improved further.

### SUMMARY OF THE INVENTION

The primary object of the present invention is to solve the above-mentioned issues and to provide a diverter assembly for holding a handheld shower nozzle, and for controlling the amount of water to flow out through either or both of a shower head and the shower nozzle steplessly.

The secondary object of the present invention is to provide a multi-position movable body for securing the shower nozzle.

For achieving the above-mentioned objects, the diverter assembly according to the present invention includes a main body, a valve device and a movable body. The main body is hollow and has a water inlet tube and two water outlet tubes. One of the two water outlet tubes is communicated through a hose to a shower nozzle. The valve device is disposed on the main body and has a valve capable of linearly moving back and forth for steplessly communicating the water inlet tube with either or both of the water outlet tubes. The movable body is pivotally disposed at one end of the main body, and has a hole for the shower nozzle to be inserted in.

Accordingly, the diverter assembly can steplessly adjust the valve position for controlling the water to flow out from any of the water outlet tubes into either or both of the shower nozzle or the shower head, so as to achieve the object of steplessly adjusting the amount of water to flow out from the shower nozzle and the shower head.

Furthermore, the movable body has an elastic engagement member and a plurality of meshing parts corresponding to the engagement member. The engagement member is inserted into the meshing parts to locate the movable body for securing the shower nozzle.

### BRIEF DESCRIPTION OF THE DRAWINGS

FIG. 1 is a schematic view of a shower appliance according to the present invention;

FIG. 2 is a perspective view of the present invention;

FIG. 3 is a cross-sectional view along the III-III cross-sectional line in FIG. 2;

FIG. 4 is a cross-sectional structural schematic view of the present invention;

FIG. 5 is a schematic view showing a first operating condition of the present invention;

FIG. 6 is a schematic view showing a second operating condition of the present invention;

FIG. 7 is a schematic view showing a third operating condition of the present invention; and

FIG. 8 is a cross-sectional structural schematic view of a main body and a pivotally disposed movable body in the second preferred embodiment of the present invention.

### DETAILED DESCRIPTION OF THE INVENTION

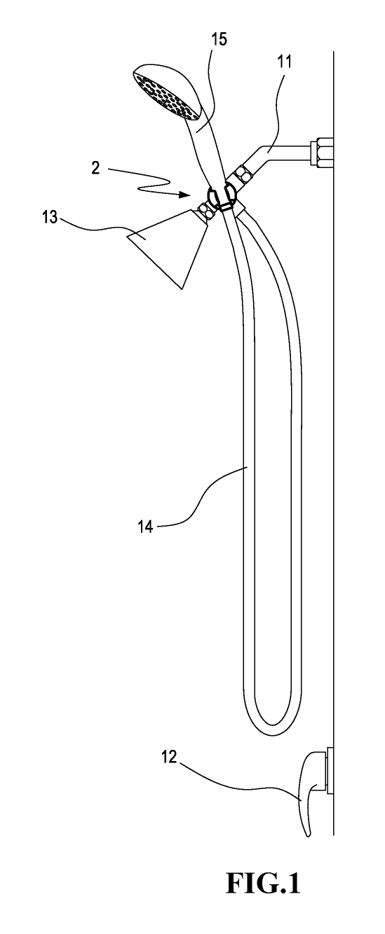

Refer to FIG. 1 to FIG. 7, which shows a preferred embodiment according to the present invention.

Refer to FIG. 1, which is a schematic view of a shower appliance according to the present invention. A shower appliance usually has a water outlet tube 11 protruding on top of a wall. The water flowing out of the water outlet tube 11 is controlled by a switch 12 disposed on bottom of the wall. The diverter assembly 2 of the present invention is integrated with the water outlet tube 11, respectively communicated with a shower head 13 and communicated with a handheld shower nozzle 15 by a hose 14.

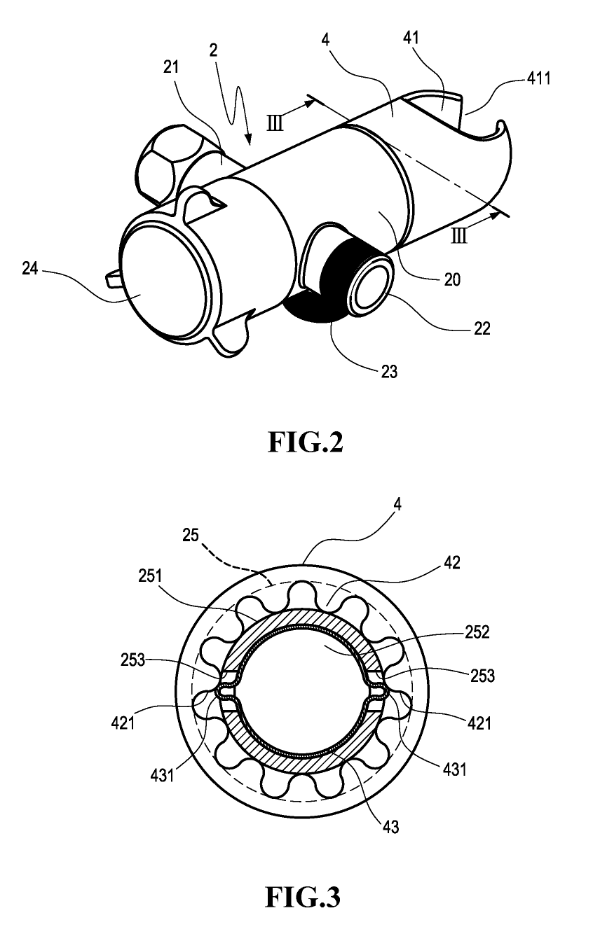

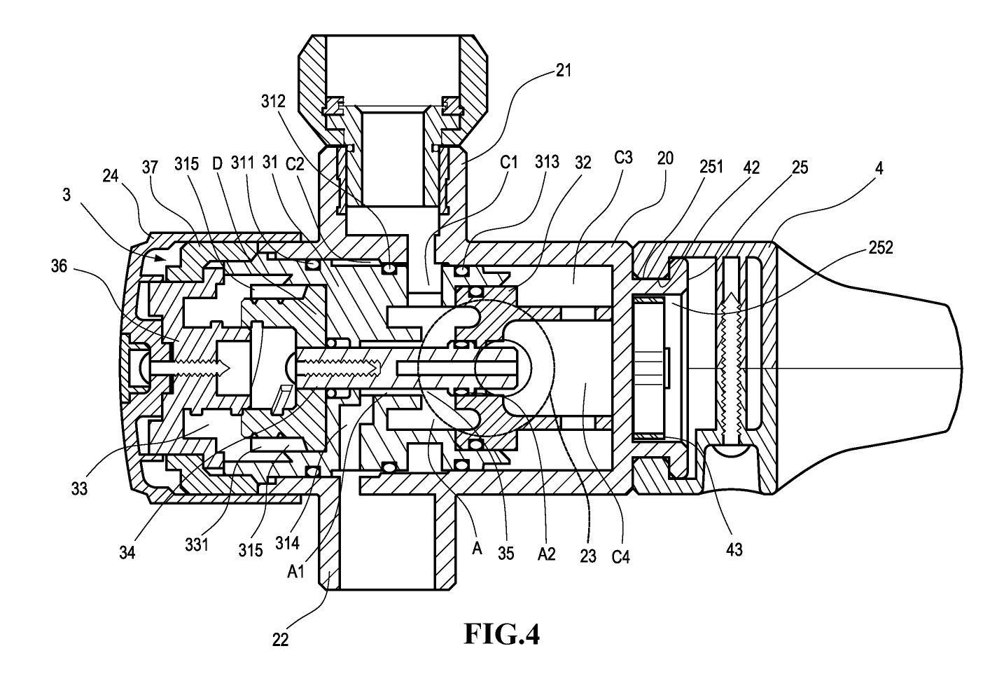

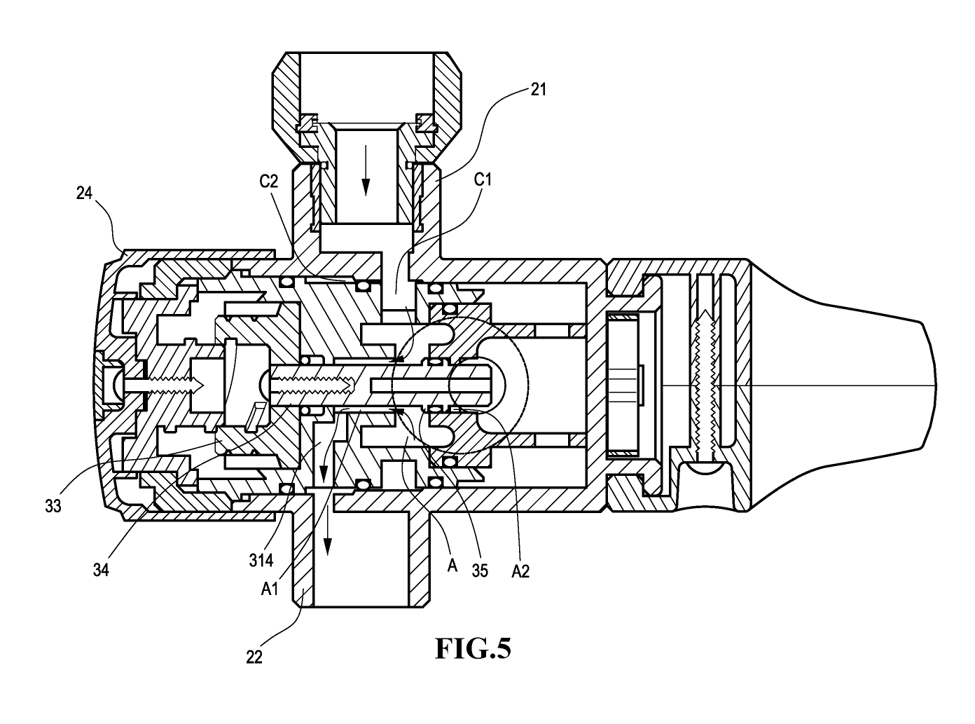

Refer to FIG. 2, which is a perspective view of the present invention. The diverter assembly 2 of the present invention has a hollow main body 20. The main body 20 has a water inlet tube 21, a first water outlet tube 22 and a second water outlet tube 23. A knob 24 is pivotally disposed at one end of the main body 20. The knob 24 rotates in accordance with a valve device 3 (referring to FIG. 4) disposed in the main body 20, and the valve device 3 controls the water to flow out from the first water outlet tube 22 and the second water outlet tube 23.

A movable body 4 is pivotally disposed at one end of the main body 20 opposing the knob 24 and has a hole 41 for the shower nozzle 15 to be inserted in, and the hole 41 has an opening 411 for a user to take or hang the shower nozzle conveniently.

Refer to FIG. 2 to FIG. 4. FIG. 3 is a cross-sectional view along the III-III cross-sectional line in FIG. 2. FIG. 4 is a cross-sectional structural schematic view of the present invention. A protruding part 25 is disposed at one end of the main body 20 opposing the knob 24 and has a ring groove 251 at an outer edge of the protruding part 25. A container 252 is disposed at the center of the protruding part 25. The protruding part 25 has at least one through hole 253 passing through the container 252 and the ring groove 251. Two through holes 253 axially opposing each other are taken as an example in the present embodiment. The moveable seat 4 has a protruding ring 42 corresponding to the ring groove 251. The protruding ring 42 has a plurality of meshing parts 421 spaced at intervals. An engagement member 43 is disposed in the container 252, and is ring-shaped and made of an elastic material such as steel. The engagement member 43 has a protruding engagement part 431 corresponding to each through hole 253 respectively, and each engagement part 431 is protruding from the ring groove 251 and inserted in the meshing part 421 as shown in FIG. 3 for securing the movable body 4 effectively.

Refer to FIG. 4. The valve device 3 in the hollow main body 20 has a first sleeve 31 and a second sleeve 32 sleeved by each other. A partition A is formed between the first sleeve 31 and the second sleeve 32, and communicates a first passage A1 and a second passage A2. Three O-rings 311, 312 and 313 are disposed separately at an outer edge of the first sleeve 31 to form a first partition C1, a second partition C2 and a third partition C3 among the main body 20, the first sleeve 31 and the second sleeve 32. The first partition C1 communicates with the water inlet tube 21. The second partition C2 communicates with the first water outlet tube 22. The third partition C3 communicates with the second water outlet tube 23.

Further, the first sleeve 31 has a first through hole 314 communicating the first passage A1 and the second partition C2 for the first passage A1 to communicate with the first water outlet tube 22. The second sleeve 32 has a fourth partition C4 communicating with the second passage A2 and the third partition C3 respectively, so that the second passage A2 communicates with the second water outlet tube 23.

A spiral sleeve 33 is slidably disposed at one end of the first sleeve 31 opposing the second sleeve 32 and integrated with an axis 34. The axis 34 extends and passes the partition A and has a valve 35 at one section of the partition A. One end of the spiral sleeve 33 opposing the axis 34 is spirally engaged with a spiral rod 36. The spiral rod 36 is pivotally disposed on the main body 20 by a cover 37, and the section thereof extending out of the cover 37 is integrated with the knob 24 for the knob 24 to rotate the spiral rod 36 and further to slide the spiral sleeve 33 and the axis 34.

Further, a container D is disposed at one end of the first sleeve 31 opposing the second sleeve 32. A sliding groove 315 is disposed respectively at two axially opposite ends of the container D. A slider 331 is disposed respectively at the spiral sleeve 33 opposing the two sliding grooves 315. The spiral sleeve 33 can slide relative to the first sleeve 31 by the cooperating of the two sliding grooves 315 and two sliders 331.

Refer to FIG. 5, which is a schematic view showing a first operating condition of the present invention. When a user rotates the knob 24 to slide the spiral sleeve 33 and the axis 34 toward the second passage A2 until the valve 35 closes the second passage A2, the water flows in through the water inlet tube 21 and then enters the partition A through the first partition C1, and then flows through the first through hole 314 and the second partition C2 from the first passage A1, and is finally sprayed from the shower head 13 through the first water outlet tube 22.

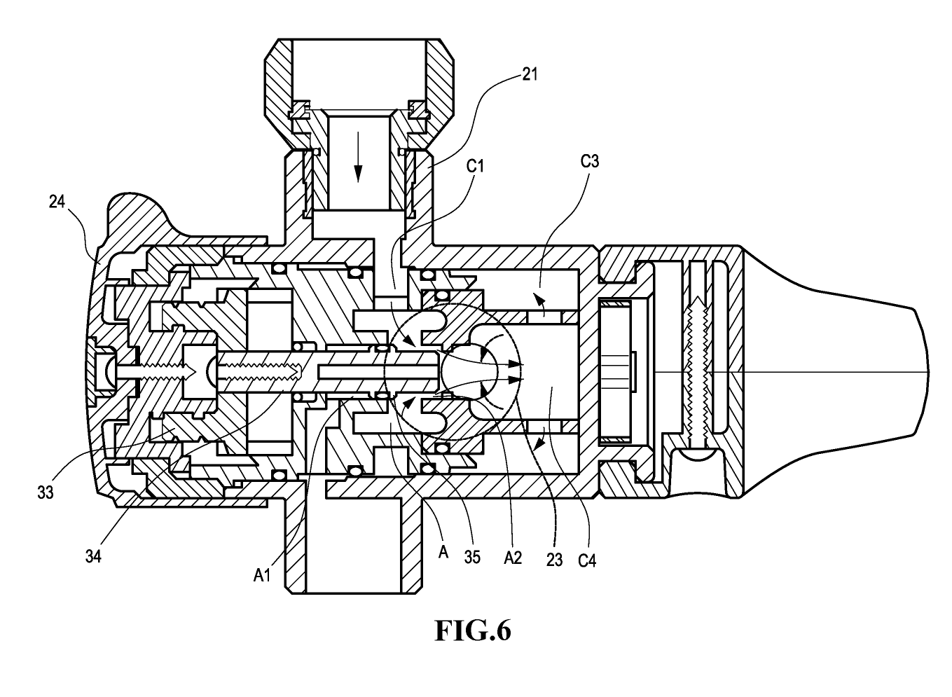

Refer to FIG. 6, which is a schematic view showing a second operating condition of the present invention. When a user wants the water to flow out of the shower nozzle 15 and rotates the knob 24 to slide the spiral sleeve 33 and the axis 34 toward the first passage A1 until the valve 35 closes the first passage A1, the water flows into through the water inlet tube 21 and then enters the partition A through the first partition C1, and onto the third partition C3 through the second passage A2 and the fourth partition C4, and finally into the hose 14 through the second water outlet tube 23 to be sprayed from the shower nozzle 15.

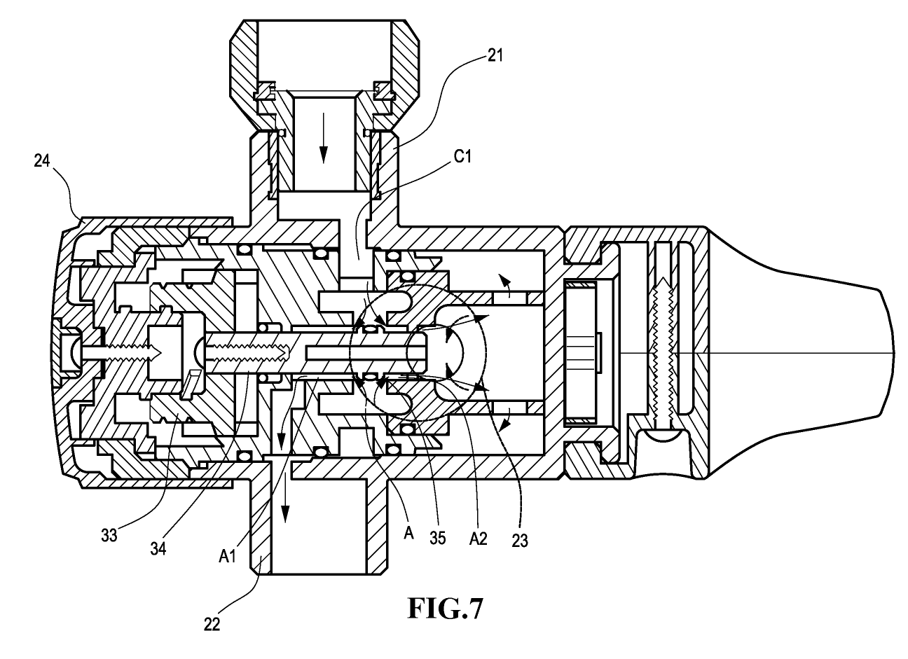

Refer to FIG. 7, which is a schematic view showing a third operating condition of the present invention. When a user wants the water to flow out of the shower head 13 and the shower nozzle 15 simultaneously and rotates the knob 24 to slide the spiral sleeve 33 and the axis 34 until the valve 35 is located between the first passage A1 and the second passage A2 and the first passage A1 communicates with the second passage A2, the water flows in through the water inlet tube 21 and then enters the partition A through the first partition C1, and onto the partition A through the first passage A1 and the second passage A2, and is finally sprayed from of the shower head 13 and the shower nozzle 15 through the first water outlet tube 22 and second water outlet tube 23, so that the water is sprayed from the shower head 13 and the shower nozzle 15 simultaneously.

If the user wants the amount of water flowing out from the shower nozzle 15 more than from the shower head 13, the user can rotate the knob 24 to slightly slide the spiral sleeve 33 and the axis 34 toward the first passage A1 so that the valve 35 is near the first passage A1 and reduces the amount of water flowing from the first passage A1 to the shower head 13 and increases the water flowing out from the shower nozzle 15. Thereby, the location of the valve 35 is finely adjusted by the knob 34 to steplessly adjust the amount of water flowing out from the shower head 13 and the shower nozzle 15.

Moreover, the hole 41 of the movable body 4 is for the shower nozzle 15 to be inserted in, and the movable body 4 is pivotally disposed on the main body 20 and is capable of rotating and locating. Thus, the movable body 4 can pivotally rotate to adjust the angle for a user to take or hang the shower nozzle 15. The engagement part 431 of the engagement member 43 on the movable body 4 can be inserted into any meshing part 421 of the protruding ring 42 for locating the movable body 4, such that the shower nozzle 15 is inserted securely in the movable body 4 and prevented from dropping as occurred in the prior art.

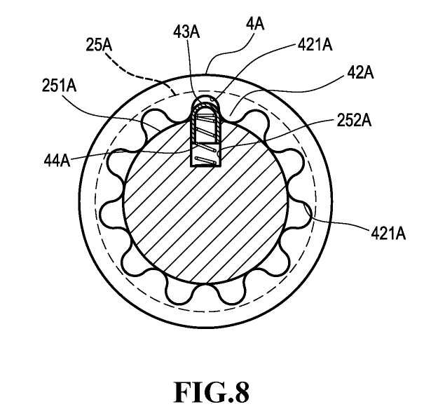

Refer to FIG. 8, which is a cross-sectional structural schematic view of a main body and a pivotally disposed movable body in the second preferred embodiment of the present invention. A protruding part 25A of the main body has a ring groove 251A, and the movable body 4A has a protruding ring 42A corresponding to the ring groove 251A. A container 252A is disposed concavely at an outer edge of the ring groove 251A, and has an engagement member 43A and a spring 44A disposed therein. In a normal condition, the spring 44A presses the engagement member 43A to protrude from the ring groove 251A. The protruding ring 42A has a plurality of meshing parts 421A corresponding to the engagement member 43A, so that the spring force of the spring 44A presses the engagement member 43A to be inserted into the meshing part 421A for locating the movable body effectively. Accordingly, the present embodiment achieves the same effect as in the first embodiment.

What is claimed is:

1. A diverter assembly for use in holding a shower head and a shower nozzle, comprising:
a main body, being hollow and having a water inlet tube and two water outlet tubes, one of the water outlet tubes communicating with the shower nozzle through a hose;
a valve device, being assembled to the main body and having a valve capable of linearly moving back and forth to steplessly adjust fluid communication among the water inlet tube and the water outlet tubes; and
a movable body, pivotally disposed at one end of the main body, the main body having a protruding part at one end thereof, the protruding part has a ring groove at an outer edge thereof, the movable body having a protruding ring corresponding to the ring groove for the movable body to be pivotally disposed on the main body by cooperating of the protruding ring and the ring groove, an elastic engagement member being disposed between the movable body and the protruding part, the protruding ring has a plurality of meshing parts corresponding to the engagement member for the engagement member to be inserted into the meshing part for locating the movable body, a hole being pivotally disposed in the movable body for the shower nozzle to be inserted in.

2. The diverter assembly for use in holding a shower head and a shower nozzle according to claim 1, wherein the valve device has a partition communicating a first passage and a second passage, the first passage and the second passage communicating with a water outlet tube respectively, the valve being disposed in the partition and capable of moving steplessly between the first passage and the second passage to close the first passage and the second passage respectively or keep the first passage and the second passage open simultaneously.

3. The diverter assembly for use in holding a shower head and a shower nozzle according to claim 2, wherein the valve device has a first sleeve and a second sleeve sleeving with each other, the partition being formed between the first sleeve and the second sleeve.

4. The diverter assembly for use in holding a shower head and a shower nozzle according to claim 2, wherein a spiral sleeve is slidably disposed at the valve device and combined with an axis, the axis extending and passing through the partition, the valve is formed on the axis, one end on the spiral sleeve opposing the axis being spirally engaged with a spiral rod, the spiral rod being pivotally disposed on the main body by a cover, the spiral rod extending out of the cover and being combined with a knob, the knob being capable of rotating the spiral rod to slide the spiral sleeve and the axis.

5. The diverter assembly for use in holding a shower head and a shower nozzle according to claim 3, wherein three O-rings are disposed separately at an outer edge of the first sleeve to form a first partition, a second partition and a third partition in the main body, the first partition communicating with the water inlet tube, the second partition and the third partition communicating with a water outlet tube respectively, the first sleeve having a first through hole communicating the first passage and the second partition for the first passage to be communicated with a water outlet tube, the second sleeve having a fourth partition communicating with the second passage and the third partition respectively for the second passage to be communicated with another water outlet tube.

6. The diverter assembly for use in holding a shower head and a shower nozzle according to claim 4, wherein the valve device has a container, at least a sliding groove being disposed at two axially opposite ends of the container, a slider being disposed respectively on the spiral sleeve opposing the two sliding grooves, the spiral sleeve being capable of linearly moving by cooperating of the two sliding grooves and the two sliders.

7. The diverter assembly for use in holding a shower head and a shower nozzle according to claim 1, wherein a container is disposed at a center of the protruding part, the protruding part having at least one through hole passing through the container and the ring groove, the engagement member is disposed in the container and is ring-shaped, the engagement member has a protruding engagement part corresponding to the through hole, the engagement part being protruding from the ring groove and inserted in the meshing part.

8. The diverter assembly for use in holding a shower head and a shower nozzle according to claim 1, wherein a container is disposed concavely at an outer edge of the ring groove and has an engagement member and a spring disposed therein, the spring pressing the engagement member to protrude from the ring groove, the protruding ring having a plurality of meshing parts corresponding to the engagement member for locating the movable body by inserting the engagement member in the meshing part.

9. The diverter assembly for use in holding a shower head and a shower nozzle according to claim 1, wherein the hole has an opening for the shower nozzle to be inserted in.
